(19) United States
(12) Patent Application Publication
(10) Pub. No.: US 2014/0112689 A1
(43) Pub. Date: Apr. 24, 2014

(54) IMAGE FORMING APPARATUS

(71) Applicant: FUJI XEROX CO., LTD., Tokyo (JP)

(72) Inventor: Masahiro KATAHIRA, Kanagawa (JP)

(73) Assignee: FUJI XEROX CO., LTD., Tokyo (JP)

(21) Appl. No.: 13/900,986

(22) Filed: May 23, 2013

(30) Foreign Application Priority Data
Oct. 24, 2012 (JP) 2012-234554

(51) Int. Cl. G03G 15/01

(52) U.S. Cl. CPC G03G 15/1605
USPC 399/302

(57) ABSTRACT

An image forming apparatus includes an image carrier having an electrostatic latent image that is formed on the image carrier and that is developed into a toner image, an intermediate transfer belt to which the toner image on the image carrier is transferred, and a second transfer belt that transfers the toner image on the intermediate transfer belt to a transfer member via a second transfer section. The intermediate transfer belt and the second transfer belt are made of a thermoplastic resin. The hardness of the second transfer belt is set to be equal to or larger than that of the intermediate transfer belt. The contact angle of a pure water droplet on a surface of the second transfer belt is set to be larger than that on a surface of the intermediate transfer belt.

### CROSS-REFERENCE TO RELATED APPLICATIONS

This application is based on and claims priority under 35 USC 119 from Japanese Patent Application No. 2012-234554 filed Oct. 24, 2012.

### BACKGROUND

(i) Technical Field

The present invention relates to an image forming apparatus.

(ii) Related Art

In general, an image forming apparatus such as an electrophotographic apparatus develops an electrostatic latent image formed on a photoconductor drum into a visible image with a charged toner (a developer), electrostatically transfers the visible toner image to a transfer member (e.g., a sheet), and finally melts and fixes the toner image by heating the toner image and applying pressure to the toner image so that an image is fixed to the sheet.

### SUMMARY

According to an aspect of the invention, there is provided an image forming apparatus including an image carrier having an electrostatic latent image that is formed on the image carrier and that is developed into a visible toner image, an intermediate transfer belt to which the toner image on the image carrier is transferred, and a second transfer belt that transfers the toner image on the intermediate transfer belt to a transfer member via a second transfer section. The intermediate transfer belt and the second transfer belt are made of a thermoplastic resin. The hardness of the second transfer belt is set to be equal to or larger than that of the intermediate transfer belt. The contact angle of a pure water droplet on a surface of the second transfer belt is set to be larger than that on a surface of the intermediate transfer belt.

### BRIEF DESCRIPTION OF THE DRAWINGS

An exemplary embodiment of the present invention will be described in detail based on the following figures, wherein:

FIG. 1 is a schematic diagram of an overall structure of an image forming apparatus according to an exemplary embodiment of the invention;

FIG. 2 is an enlarged schematic view of a principal portion of the image forming apparatus according to the exemplary embodiment of the invention; and

FIGS. 3A to 3C are explanatory diagrams sequentially illustrating the mechanism of occurrence of a filming phenomenon on a second transfer belt.

### DETAILED DESCRIPTION

An exemplary embodiment according to the present invention will be described in detail below with reference to the drawings.

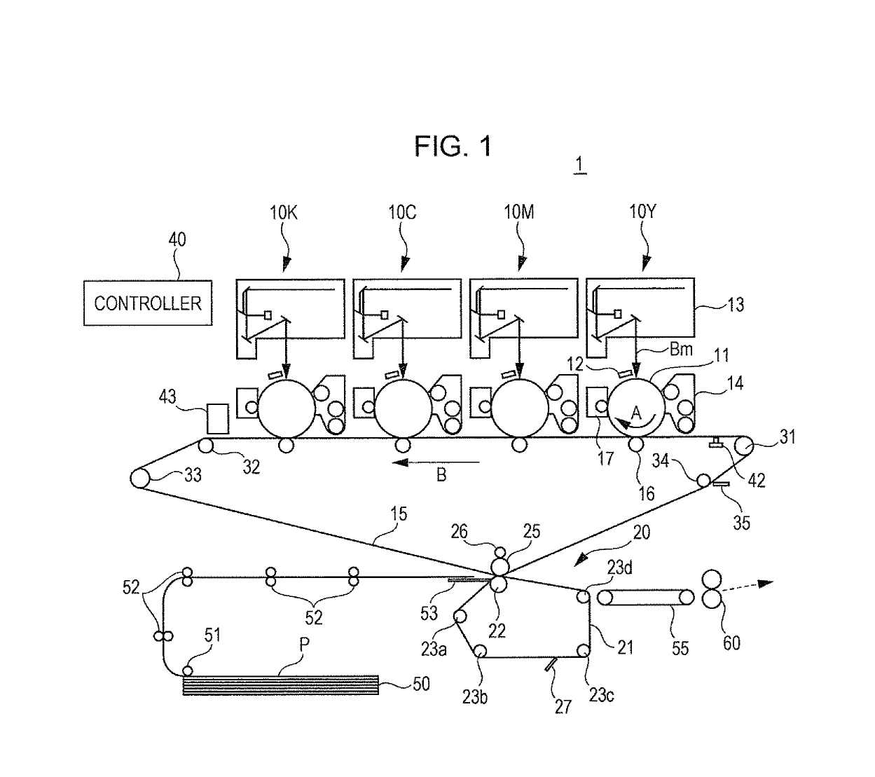

An image forming apparatus 1 that is called a tandem type image forming apparatus employing an intermediate transfer system is illustrated in FIG. 1. The image forming apparatus 1 includes image forming units 10 (10Y, 10M, 10C, 10K) in which toner images each having a different color component are formed by an electrophotographic system, an intermediate transfer belt 15 to which the toner images of different color components formed in the image forming units 10 are sequentially transferred (first-transferred) and by which the toner images are held, a second transfer section 20 that collectively transfers (second-transfers) a superimposed toner image that has been formed on the intermediate transfer belt 15 to a sheet P that is a transfer member, and a fixing unit 60 that fixes the image that has been second-transferred on the sheet P onto the sheet P. A series of operations of the image forming apparatus 1 are controlled by a controller 40.

In the image forming units 10 (10Y, 10M, 10C, 10K), devices for electrophotography including chargers 12, exposure units 13, developing devices 14, first transfer rollers 16, and drum cleaners 17 are sequentially arranged at the periphery of photoconductor drums 11 that function as image carriers and that rotate in the direction of arrow A of FIG. 1.

The chargers 12 charge the photoconductor drums 11, and the exposure units 13 write electrostatic latent images on the photoconductor drums 11. Exposure beams are indicated by a reference numeral Bm in FIG. 1. Each of the developing devices 14 contains a toner having a color component different from the others and converts an electrostatic latent image on the corresponding photoconductor drum 11 into a visible image with the toner. The first transfer rollers 16 transfer toner images of different color components formed on the photoconductor drums 11 to the intermediate transfer belt 15, and the drum cleaners 17 remove residual toner on the photoconductor drums 11. The image forming unit 10Y (yellow), the image forming unit 10M (magenta), the image forming unit 100 (cyan), and the image forming unit 10K (black) are arranged in series in this order from the upstream side of the intermediate transfer belt 15.

Various rollers cause the intermediate transfer belt 15 to circularly move in the direction of arrow B shown in FIG. 1 at a predetermined speed. The various rollers include a driving roller 31, a support roller 32, a tension roller 33, a backup roller 25, and a cleaning backup roller 34. The driving roller 31 is driven by a motor having a good constant speed characteristic (not shown) so as to cause the intermediate transfer belt 15 to circularly move. The support roller 32 supports the intermediate transfer belt 15 extending substantially linearly along a direction in which the photoconductor drums 11 are arranged. The tension roller 33 exerts a certain tension on the intermediate transfer belt 15 and prevents the intermediate transfer belt 15 from moving in a serpentine manner. The backup roller 25 is provided in the second transfer section 20 and defines a nip between the backup roller 25 and a second transfer roller 22 that will be described below. The cleaning backup roller 34 is provided in a cleaning section in which residual toner on the intermediate transfer belt 15 is to be scraped off.

A voltage having a polarity opposite to the charge polarity of toner is applied to the first transfer rollers 16 arranged on the inner side of the intermediate transfer belt 15 that extends substantially linearly and that opposes the photoconductor drums 11 of the image forming units 10 (10Y, 10M, 10C, 10K). Because of this, the toner images on the photoconductor drums 11 are sequentially and electrostatically attracted to the intermediate transfer belt 15, and thus, a superimposed toner image is formed on the intermediate transfer belt 15. The backup roller 25 is disposed on the inner side of the intermediate transfer belt 15 and functions as an electrode facing a second transfer belt 21, and a metallic power supplying roller 26 for stably applying a second transfer bias to the backup roller 25 is disposed so as to be in contact with the backup roller 25.

The second transfer belt 21 is an endless annular belt that is stretched by the second transfer roller 22 and idle rollers 23a to 23d. The second transfer roller 22 causes the second transfer belt 21 to circularly move at a predetermined speed, and the idle rollers 23a to 23d exert a predetermined tension on the second transfer belt 21. The idle rollers 23a to 23d are four idle rollers and are arranged so as to form the vertices of a pentagon together with the second transfer roller 22, and the second transfer belt 21 is extended around the second transfer roller 22 and the idle rollers 23a to 23d.

The second transfer roller 22 is disposed so as to be press-contacted against the backup roller 25 with the second transfer belt 21 and the intermediate transfer belt 15 being nipped therebetween. The second transfer roller 22 functions as a second transfer roller for performing a second transfer operation on the sheet P that is to be transported on the second transfer belt 21.

The second transfer section 20 includes the intermediate transfer belt 15, the second transfer belt 21 disposed on the side of a surface of the intermediate transfer belt 15 on which toner images are carried, and the second transfer roller 22 and the backup roller 25 nipping a portion in which the intermediate transfer belt 15 and the second transfer belt 21 are in contact with each other from both sides of the portion. A cleaning blade 27 that is formed of a rubber plate member and that scrapes off toners remaining on a surface of the second transfer belt 21 is disposed on the downstream side of the second transfer section 20 so as to be in contact with the second transfer belt 21.

A belt cleaner 35 is provided on a portion of the intermediate transfer belt 15 on the downstream side of the second transfer section 20 so as to be able to come into contact with or move away from the intermediate transfer belt 15 as needed. The belt cleaner 35 removes residual toner and paper dust on the intermediate transfer belt 15 after a second transfer operation and cleans the intermediate transfer belt 15. A reference sensor 42 that generates a reference signal that functions as a reference for controlling the timing of image formation in the image forming units 10 (10Y, 10M, 10C, 10K) is arranged on the upstream side of the yellow image forming unit 10Y. The reference sensor 42 generates the reference signal when it recognizes a predetermined mark on the intermediate transfer belt 15, and the image forming units 10 (10Y, 10M, 10C, 10K) start image formation in response to an instruction from the controller 40 that is based on recognition of the reference signal. An image density sensor 43 for adjusting image quality is disposed on the downstream side of the black image forming unit 10K.

The image forming apparatus 1 further includes, as a sheet transport system, a sheet tray 50 that contains the sheet P, a sheet feed roller 51 that pulls out and transports one of sheets P stacked in the sheet tray 50 at a predetermined timing, a transport roller 52 that transports the sheet P that has been sent by the sheet feed roller 51, a transport chute 53 that sends the sheet P that has been transported by the transport roller 52 to the second transfer section 20, and a transport belt 55 that transports the sheet P that is to be transported after a second transfer operation is performed on the sheet P by the second transfer belt 21 to the fixing unit 60.

Next, operation of the image forming apparatus 1 according to the exemplary embodiment will be described. In FIG. 1, in the image forming units 10 (10Y, 10M, 10C, 10K), the photoconductor drums 11 rotate in the direction of arrow A of FIG. 1, and surfaces of the photoconductor drums 11 are uniformly charged by the chargers 12. Electrostatic latent images each having a color component corresponding to one of the photoconductor drums 11 are formed on the corresponding photoconductor drums 11, which have been charged, by the exposure units 13. Each of the electrostatic latent images is developed with toner by one of the developing devices 14 having a color component corresponding to the electrostatic latent image, and as a result, visible toner images are formed on the photoconductor drums 11.

The toner images reach first transfer sections, in which the first transfer rollers 16 are arranged, by rotation of the photoconductor drums 11. An electric field formed between the first transfer rollers 16 and the photoconductor drums 11 and having a polarity opposite to that of the toner images acts on the toner images, and thus, the toner images are electrostatically first-transferred onto the intermediate transfer belt 15, which moves in the direction of arrow B of FIG. 1. The toner images of different color components formed in the image forming units 10 are sequentially superimposed at predetermined positions on the intermediate transfer belt 15 on the basis of the signal from the reference sensor 42, and as a result, superimposed toner images are formed.

After that, the superimposed toner images that have been formed on the intermediate transfer belt 15 reach the nip of the second transfer section 20 by circular movement of the intermediate transfer belt 15. The sheet P is fed at a predetermined timing from the transport chute 53 to the portion of the second transfer section 20 in which the intermediate transfer belt 15 and the second transfer belt 21 are in contact with each other. The superimposed toner images on the intermediate transfer belt 15 are collectively transferred (second-transferred) to the sheet P, which has been fed to the portion, while the sheet P is passing through the nip defined between the second transfer roller 22 and the backup roller 25.

Then, the sheet P, on which the superimposed toner images have been transferred, is transported to the fixing unit 60 by the transport belt 55 after it is separated from the intermediate transfer belt 15. The sheet P is subjected to a pressure and heat treatment in the fixing unit 60, and the toner images on the sheet P are secured and fixed to the sheet P so as to become permanent images.

A portion of the intermediate transfer belt 15 that has been used to complete the operation of transferring the superimposed toner images to the sheet P reaches the belt cleaner 35 disposed on the downstream side of the second transfer section 20, and adhered toner and paper dust on the intermediate transfer belt 15 are removed. On the other hand, residual toner that remains on the second transfer belt 21 after the transfer from the intermediate transfer belt 15 is scraped off by the cleaning blade 27.

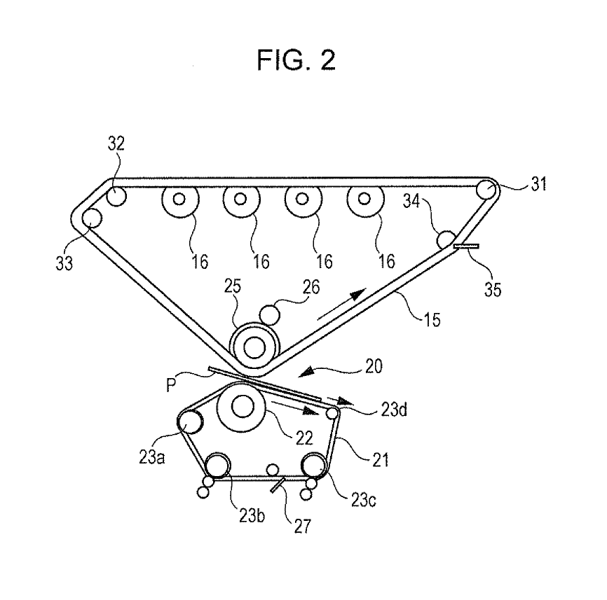

In the image forming apparatus 1 according to the exemplary embodiment, as illustrated in FIG. 2, the second transfer belt 21 is disposed in the second transfer section 20 that transfers a toner image carried by the intermediate transfer belt 15 to the sheet P. Since the intermediate transfer belt 15 passes between the photoconductor drums 11 of the image forming units 10 (10Y, 10M, 10C, 10K) that are arranged in series and the first transfer rollers 16, the peripheral length of the intermediate transfer belt 15 is longer than that of the second transfer belt 21. In the exemplary embodiment, the intermediate transfer belt 15 has a width of 360 mm and a peripheral length of 2,910 mm, and the second transfer belt 21 has a width of 360 mm and a peripheral length of 410 mm.

The image forming apparatus 1 has been applied to, for example, a production apparatus used by a printer, and there is a need for the image forming apparatus 1 to be able to transport thick paper and thin paper. In particular, in order to secure detachability of thin paper when thin paper is transported, the second transfer belt 21 in the form of an endless belt is used for a second transfer operation in the exemplary embodiment. Although second transfer belts of the related art are generally made of an elastic material, there has been a problem concerning mechanical durability such as cracks that occur due to use over time.

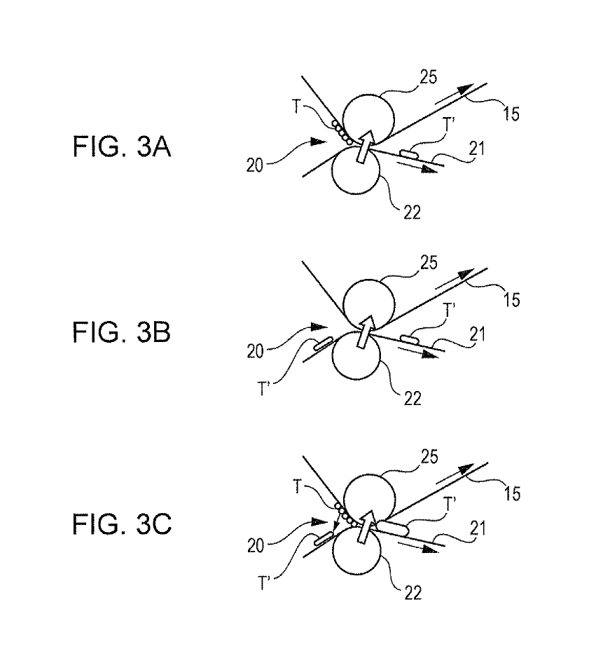

Mechanical durability may be improved by making the intermediate transfer belt 15 and the second transfer belt 21 out of a thermoplastic resin material. However, when a hard, thermoplastic resin material is used for making both the intermediate transfer belt 15 and the second transfer belt 21, the contact pressure at the nip defined by these belts that are in contact with each other is high. In this case, as illustrated in FIGS. 3A to 3C, the residual toner that remains on the second transfer belt 21 after the transfer from the intermediate transfer belt 15 and fog toner are fixed to the nip to which a high pressure is applied. If this phenomenon repeatedly occurs, and toners are accumulated and fixed to the nip, this results in a filming phenomenon.

In particular, the amount of toner that is transferred to the second transfer belt 21 per unit area of the second transfer belt 21, which has a peripheral length shorter than that of the intermediate transfer belt 15, is greater than that transferred to the intermediate transfer belt 15 per unit area of the intermediate transfer belt 15, and thus, filming notably occurs on the second transfer belt 21. If filming occurs on the second transfer belt 21, transfer failure or unevenness in an image occurs at a position at which the filming has occurred, and failure of cleaning the second transfer belt 21 also occurs.

In other words, in the mechanism of occurrence of filming, as illustrated in FIG. 3A, the intermediate transfer belt 15 and the second transfer belt 21 are rubbed against each other while being in contact with each other in the second transfer section 20, and thus, a toner T on the intermediate transfer belt 15 is transferred to the second transfer belt 21 and becomes an adhered toner T′. Next, as illustrated in FIG. 3B, when the second transfer belt 21 circularly moves, and a portion of the second transfer belt 21 to which the adhered toner T′ has been adhered reaches the second transfer section 20, the adhered toner T′ is strongly pressed against and fixed onto the second transfer belt 21 by a pressure exerted by the second transfer roller 22 and the backup roller 25, and this results in filming. As illustrated in FIG. 3C, the adhered toner T′, which has been fixed to the second transfer belt 21, grows (e.g., 20 μm or more) in the same way that a snowball grows as it rolls down a snow-covered hill as the intermediate transfer belt 15 and the second transfer belt 21 repeatedly are rubbed against each other while being in contact with each other, and this results in hard filming.

In the exemplary embodiment, filming that occurs due to the toner T fixed to the second transfer belt 21 may be suppressed by improving the ability of the second transfer belt 21 having a short peripheral length to repel the toner T therefrom. When the intermediate transfer belt 15 and the second transfer belt 21 are made of a thermoplastic resin, in the case where the hardness of the second transfer belt 21 is set to be larger than that of the intermediate transfer belt 15, the pressure generated by contact between the belts 15 and 21 in the second transfer section 20 may be reduced as compared with the case where the hardnesses of the intermediate transfer belt 15 and the second transfer belt 21 are both equally large. Obviously, a material having a desired flexibility may be used as a thermoplastic resin, and a polyimide that has a high mechanical durability may be used as a thermoplastic resin material in the exemplary embodiment.

In the case where a polyimide is used as a thermoplastic resin material, in the exemplary embodiment, a fluorocarbon resin is added to a polyimide so that the ability of the second transfer belt 21 to repel the toner T therefrom may be improved. Note that the thermoplastic resin material is not limited to a polyimide, and other synthetic resins having thermoplasticity, such as a polyamidoimide, may be used. Although the case where the hardness of the second transfer belt 21 is set to be larger than that of the intermediate transfer belt 15 is described above, the hardnesses of the second transfer belt 21 and the intermediate transfer belt 15 may be the same.

Polytetrafluoroethylene (hereinbelow referred to as PTFE) that has been widely used is used as the above-mentioned fluorocarbon resin to be added. In the exemplary embodiment, PTFE having a particle diameter of 6 μm may be added to the second transfer belt 21 or may be added to the second transfer belt 21 and the intermediate transfer belt 15. In the case where PTFE is added to the second transfer belt 21 and the intermediate transfer belt 15, the amount of PTFE added to the second transfer belt 21 is set to be larger than that added to the intermediate transfer belt 15. Because of this, the second transfer belt 21 may more easily repel the toner T therefrom than the intermediate transfer belt 15 does. An appropriate amount of PTFE added to the belts is in the range of 1 to 20 wt %, and in particular, 10 wt % of PTFE is added to the second transfer belt 21 that is to be able to easily repel the toner T therefrom.

PTFE is added to the second transfer belt 21 made of a polyimide, so that PTFE that is exposed on the surface of the second transfer belt 21 spreads out as a result of being rubbed against the intermediate transfer belt 15, the cleaning blade 27, the sheet P, and the like. As a result, the second transfer belt 21 is covered with PTFE.

In the case where PTFE is added to the intermediate transfer belt 15, in the same way as described above, PTFE spreads out as a result of by being rubbed against the second transfer belt 21, the belt cleaner 35, and the like, and as a result, the intermediate transfer belt 15 will be covered with PTFE. Therefore, the second transfer belt 21 and the intermediate transfer belt 15 are covered with PTFE, and thus, the belts may more easily repel the toner T therefrom. Since the amount of PTFE added to the second transfer belt 21 is set to be larger than that added to the intermediate transfer belt 15, the second transfer belt 21 may more easily repel the toner T therefrom than the intermediate transfer belt 15 does.

Although the second transfer belt 21 and the intermediate transfer belt 15 become worn due to use over time, PTFE covering the surface of each of the belts as described above functions as a coating film, and thus, the degree of wear of the belts may be reduced. Although the case where PTFE is used as a fluorocarbon resin is described above, the fluorocarbon resin is not limited to PTFE, and other fluorocarbon resins such as a perfluoroalkoxy fluorocarbon resin (PFA), a polyvinyl fluoride (PVF), a polyvinylidene fluoride (PVDF), and the like may be used.

The contact angle of a liquid droplet is a method of measuring the water repellency of a solid surface. As is commonly known, the contact angle of a liquid droplet is an important factor for evaluating characteristics of an interface between solid and liquid and has been widely used as a method of converting, for example, water repellency into numbers. In this method, a certain quantity of liquid is dropped onto a solid sample, and the contact angle formed between a surface of the liquid droplet that is raised on the solid and the solid surface is calculated. Here, the description of the calculation method will be omitted.

In the exemplary embodiment, since the surface of the second transfer belt 21 is covered with PTFE as described above, the contact angle of a liquid droplet on the surface of the second transfer belt 21 is large. A pure water droplet is used as the liquid droplet in the exemplary embodiment. In the case where PTFE is added to the intermediate transfer belt 15, since the amount of PTFE added to the second transfer belt 21 is larger than that added to the intermediate transfer belt 15, the contact angle of the pure water droplet on the surface of the second transfer belt 21 is larger than that on the surface of the intermediate transfer belt 15. In other words, as the contact angle of a pure water droplet increases, the water repellency of the belts, that is, the ability of the belts to repel a pure water droplet therefrom increases. Thus, when the contact angle of a pure water droplet on the second transfer belt 21 is larger than that on the intermediate transfer belt 15, the second transfer belt 21 may more easily repel a pure water droplet therefrom than the intermediate transfer belt 15 does.

Here, a durability test is conducted on the image forming apparatus 1 having the above-described configuration by printing on 400,000 sheets of A3 paper. In this case, Color 1000 Press manufactured by Fuji Xerox Co., Ltd. is used as the image forming apparatus 1. This test is conducted in the case where PTFE is added to the second transfer belt 21 made of a thermoplastic resin (a polyimide) and in the case where PTFE is not added to the second transfer belt 21. PTFE is not added to the intermediate transfer belt 15.

As a result of the test, occurrence of filming on the second transfer belt 21 is not observed in the case where PTFE is added to the second transfer belt 21. On the other hand, occurrence of filming on the second transfer belt 21 is observed in the case where PTFE is not added to the second transfer belt 21. Here, the ability of the surfaces of the intermediate transfer belt 15 and the second transfer belt 21 to repel a pure water droplet therefrom in the case where occurrence of filming is not observed are determined by the contact angle of a pure water droplet as described above, and the results are shown in Table 1.

TABLE 1

| | I/B side | | Center | O/B side | |
|---|---|---|---|---|---|
| | 20 mm | 80 mm | 180 mm | 20 mm | 80 mm |
| | (Non-A3 | (A3 | (A3 | (A3 | (A3 |
| | paper- | paper- | paper- | paper- | paper- |
| | passing | passing | passing | passing | passing |
| | Portion) | Portion) | Portion) | Portion) | Portion) |
| Intermediate | 74 | 76 | 79 | 77 | 71 |
| Transfer | | | | | |
| Belt | | | | | |
| Second | 85 | 91 | 94 | 93 | 86 |
| Transfer | | | | | |
| Belt | | | | | |

Positions at which the contact angles of pure water droplets shown in Table 1 are determined include positions 20 mm away from ends on inner sides of the intermediate transfer belt 15 and the second transfer belt 21 (I/B) (non-A3 paper-passing portions), positions 80 mm away from the ends of I/B (A3 paper-passing portions), positions 20 mm away from ends on outer sides of the belts (O/B) (non-A3 paper-passing portions), positions 80 mm away from the ends of O/B (A3 paper-passing portions), and positions 180 mm away from ends on the sides to be the centers of the belts in a width direction of the belts (A3 paper-passing portions).

As a result of the test, the contact angles of the pure water droplets on the intermediate transfer belt 15 are in the range of 71 degrees to 79 degrees, and on the other hand, the contact angles of the pure water droplets on the second transfer belt 21 are in the range of 85 degrees to 94 degrees, which are high values. Accordingly, the second transfer belt 21 to which PTFE is added more easily repels a pure water droplet therefrom compared with the case where PTFE is not added to the second transfer belt 21, and thus, the second transfer belt 21 to which PTFE is added has the effect of suppressing the occurrence of filming. In particular, the marked effect of suppressing occurrence of filming is achieved with the second transfer belt 21 having a relatively high ability to repel a pure water droplet therefrom.

Although the exemplary embodiment of the present invention is described in detail above, the present invention is not limited to the exemplary embodiment, and various modifications may be made within the gist of the present invention. Examples of image forming apparatuses to which the present invention is applied include industrial on-demand printing apparatuses and copying machines and printers for home use.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image carrier having an electrostatic latent image that is formed on the image carrier and that is developed into a visible toner image;
an intermediate transfer belt to which the toner image on the image carrier is transferred; and
a second transfer belt that transfers the toner image on the intermediate transfer belt to a transfer member via a second transfer section,
wherein the intermediate transfer belt and the second transfer belt are made of a thermoplastic resin,
a hardness of the second transfer belt is set to be equal to or larger than that of the intermediate transfer belt, and
a contact angle of a pure water droplet on a surface of the second transfer belt is set to be larger than that on a surface of the intermediate transfer belt.

2. The image forming apparatus according to claim 1,
wherein a fluorocarbon resin is added to the second transfer belt.

3. The image forming apparatus according to claim 2,
wherein a fluorocarbon resin is added to the intermediate transfer belt, and the amount of the fluorocarbon resin added to the second transfer belt is larger than that added to the intermediate transfer belt.

4. The image forming apparatus according to claim 2,
wherein the fluorocarbon resin is polytetrafluoroethylene.

5. The image forming apparatus according to claim 3,
wherein the fluorocarbon resin is polytetrafluoroethylene.

6. The image forming apparatus according to claim 1,
wherein the thermoplastic resin out of which the intermediate transfer belt and the second transfer belt are made is a polyimide or polyamidoimide.

7. The image forming apparatus according to claim 2,
wherein the thermoplastic resin out of which the intermediate transfer belt and the second transfer belt are made is a polyimide or polyamidoimide.

8. The image forming apparatus according to claim 3,
wherein the thermoplastic resin out of which the intermediate transfer belt and the second transfer belt are made is a polyimide or polyamidoimide.

9. The image forming apparatus according to claim 4,
wherein the thermoplastic resin out of which the intermediate transfer belt and the second transfer belt are made is a polyimide or polyamidoimide.
